(19) United States
(12) Patent Application Publication
(10) Pub. No.: US 2025/0036998 A1
(43) Pub. Date: Jan. 30, 2025

(54) APPARATUS AND METHOD FOR PERFORMING DIGITAL-ANALOG QUANTUM COMPUTATION OPERATIONS AND COMPUTER PROGRAM PRODUCT

(71) Applicant: IQM FINLAND OY, Espoo (FI)

(72) Inventors: Hermanni HEIMONEN, Espoo (FI); Adrian AUER, Espoo (FI); Vicente PINA CANELLES, Espoo (FI)

(21) Appl. No.: 18/696,796

(22) PCT Filed: Sep. 29, 2021
(86) PCT No.: PCT/FI2021/050637

§ 371 Date: Mar. 28, 2024

(51) Int. Cl. G06N 10/60; G06N 10/40

(52) U.S. Cl. CPC G06N 10/60; G06N 10/40

(57) ABSTRACT

The invention is generally related to the field of quantum computing and particularly to a technique that allows multi-qubit couplings in a multi-qubit system to be tuned during a Digital-Analog Quantum Computation (DAQC) operation. For this purpose, a conversion matrix is used, which allows one to go from a resource Hamiltonian of the multi-qubit system to a target Hamiltonian of suitable type. Since each of the initial and target Hamiltonians defines a different set of pairs of interconnected qubits in the multi-qubit system, it is possible, by using the conversion matrix, to effectively tune multi-qubit couplings during the DAQC operation and, as a consequence, properly adjust operating parameters of analog blocks used in the DAQC operation. All of this may allow one to reduce computation errors during the DAQC operation, as well as to achieve higher fidelities as compared to the current quantum computer architectures.

### FIELD OF THE INVENTION

The invention is generally related to the field of quantum computing. In particular, the invention is related to a method and apparatus for performing Digital-Analog Quantum Computation (DAQC) operations, as well as to a corresponding computer program product.

### BACKGROUND OF THE INVENTION

Quantum computing is a new framework for computation, which aims at outperforming classical computation, by exploiting quantum mechanical phenomena. In this regard, it is necessary to introduce a qubit, which is a basic unit of quantum information. The qubit may be considered as the quantum analog of a classical bit. It is representative of a physical system that may be in two different states, generally denoted by |0 [symbol] and |1 [symbol] , as well as in a superposition of those two states, e.g., (|0 [symbol] +|1 [symbol] )/\sqrt{2}. The latter is exactly what, with some extra ingredients, plays an important role in the development of quantum algorithms outperforming classical algorithms. One example of the physical device that may be used as a qubit is an electron spin.

The time evolution of qubits is specified by a unitary operator acting on qubit states. The unitary operator plays the role of a gate in the quantum computing. In general, these gates are generated via some Hamiltonian that makes a qubit system to evolve in time. This is an analog approach, and it has the disadvantage that both time and the Hamiltonian need to be specified. Generally, one should only care about a unitary matrix, but there may be more than one way of generating it via different Hamiltonians and times. Furthermore, these implementations vary between different quantum computer architectures. That is why another paradigm has been developed, which is called a digital quantum computation (DQC) paradigm. In the DQC paradigm, it is required to specify only the unitary matrix to be used to evolve the qubits.

There has been also developed an alternative approach, called a DAQC paradigm, which uses single qubit rotations as digital blocks and uses analog evolutions as multi-qubit gates (analog blocks). The DAQC paradigm leads fewer errors and higher fidelities, as compared to the DOC paradigm. However, some current quantum computer architectures (e.g., those based on Rydberg atoms) are not able to efficiently tune multi-qubit couplings during a computing operation.

### SUMMARY

This summary is provided to introduce a selection of concepts in a simplified form that are further described below in the detailed description. This summary is not intended to identify key features of the invention, nor is it intended to be used to limit the scope of the invention.

The objective of the invention is to provide a technical solution that allows one or more multi-qubit couplings to be tuned during a DAQC operation.

The objective above is achieved by the features of the independent claims in the appended claims. Further embodiments and examples are apparent from the dependent claims, the detailed description, and the accompanying drawings.

According to a first aspect, an apparatus for performing a DAQC operation in a multi-qubit system is provided. The apparatus comprises a data storage unit, a central processing unit (CPU) connected to the data storage unit, and a quantum processing unit (QPU) connected to the CPU. The data storage unit stores processor-executable instructions which, when executed by the CPU, cause the CPU to operate as follows. At first, the CPU receives a resource Hamiltonian and a target Hamiltonian. The resource Hamiltonian is defined based on the multi-qubit system and indicative of at least one first pair of interconnected qubits in the multi-qubit system. The target Hamiltonian is defined based on the DAQC operation and indicative of at least one second pair of interconnected qubits in the multi-qubit system. Further, the CPU uses the resource Hamiltonian to build an intermediate quantum circuit for performing the DAQC operation. The intermediate quantum circuit comprises at least one analog block that has a first set of operating parameters. After that, the CPU uses the target Hamiltonian to define a second set of operating parameters for the at least one analog block such that the second set of operating parameters is related with the first set of operating parameters via a conversion matrix. The conversion matrix is invertible. Further, the CPU obtains a final quantum circuit for performing the DAQC operation based on the second set of operating parameters and the intermediate quantum circuit and provide the final quantum circuit to the QPU. In this configuration, the apparatus according to the first aspect may effectively tune the parameters of the analog block(s) of the quantum circuit or, in other words, multi-qubit couplings (also referred to as a multi-qubit interaction strength) in the multi-qubit system during the DAQC operation. The possibility of said tuning may in turn allow one to reduce computation errors, as well as to achieve higher fidelities as compared to the current quantum computer architectures.

In one embodiment of the first aspect, the at least one second pair of interconnected qubits is different from the at least one first pair of interconnected qubits. This means that the apparatus according to the first aspect may deal with differently defined Hamiltonians, which increases its flexibility-in-use.

In one embodiment of the first aspect, the multi-qubit system is based on a set of Rydberg atoms. The set of Rydberg atoms is characterized by an atom spacing. In this embodiment, the resource Hamiltonian is defined based on the atom spacing. Thus, the apparatus according to the first aspect may be used to perform the DAQC operation on the Rydberg atoms, thereby increasing its flexibility-in-use.

In another embodiment of the first aspect, the multi-qubit system is based on a set of nitrogen-vacancy (NV) centers. The set of NV centers is characterized by a NV center spacing. In this embodiment, the resource Hamiltonian is defined based on the NV center spacing. Thus, the apparatus according to the first aspect may be used to perform the DAQC operation on the NV centers, thereby increasing its flexibility-in-use.

In one embodiment of the first aspect, the DAQC operation comprises a quantum Fourier transform or a generation of Greenberger-Horne-Zeilinger (GHZ) states. Given this, the apparatus according to the first aspect may be applied to solve some of the most relevant tasks of the quantum computing, thereby increasing its flexibility-in-use.

In one embodiment of the first aspect, the first set of operating parameters comprises at least one first running time and at least one first coupling coefficient for the at least one analog block, while the second set of operating parameters comprises at least one second running time and at least one second coupling coefficient for the at least one analog block. By using these running times and coupling coefficients, one may tune the multi-qubit interaction strength during the DAQC operation in a simpler and more efficient manner.

In one embodiment of the first aspect, a number of the at least one first pair of interconnected qubits is equal to a number of the at least one second pair of interconnected qubits. In this case, the total qubit connectivity may be remained upon tuning the multi-qubit interaction strength during the DAQC operation. This may be useful in some DAQC-related applications.

In one embodiment of the first aspect, the conversion matrix is a binary matrix. The binary type of the conversion matrix is much easier to build and use when tuning the multi-qubit interaction strength during the DAQC operation.

In one embodiment of the first aspect, the second set of operating parameters is related with the first set of operating parameters via an inversion of the conversion matrix. This may allow one to tune the multi-qubit interaction strength during the DAQC operation in a much easier manner.

In one embodiment of the first aspect, the at least one first pair of interconnected qubits comprises non-overlapping pairs of interconnected qubits, and the at least one second pair of interconnected qubits comprises non-overlapping pairs of interconnected qubits. This means that the apparatus according to the first aspect may be applied to the multi-qubit system with not all-to-all connectivity, i.e., when each pair of interconnected qubits comprises different qubits.

According to a second aspect, a method for performing a DAQC operation in a multi-qubit system is provided. The method is performed by a CPU and starts with the step of receiving a resource Hamiltonian and a target Hamiltonian. The resource Hamiltonian is defined based on the multi-qubit system and indicative of at least one first pair of interconnected qubits in the multi-qubit system. The target Hamiltonian is defined based on the DAQC operation and indicative of at least one second pair of interconnected qubits in the multi-qubit system. Next, the method proceeds to the step of obtaining, based on the resource Hamiltonian, an intermediate quantum circuit for performing the DAQC operation. The intermediate quantum circuit comprises at least one analog block that has a first set of operating parameters. After that, the method goes on to the step of defining, based on the target Hamiltonian, a second set of operating parameters for the at least one analog block such that the second set of operating parameters is related with the first set of operating parameters via a conversion matrix. The conversion matrix is invertible. The method then proceeds to the step of obtaining a final quantum circuit based on the second set of operating parameters and the intermediate quantum circuit. The method ends up with the step of modifying the quantum circuit based on the conversion matrix and providing the final quantum circuit to a QPU. By so doing, it is possible to effectively tune the parameters of the analog block(s) of the quantum circuit or, in other words, the multi-qubit interaction strength in the multi-qubit system during the DAQC operation. The possibility of said tuning may in turn allow one to reduce computation errors, as well as to achieve their higher fidelities as compared to the current quantum computer architectures.

In one embodiment of the second aspect, the at least one second pair of interconnected qubits is different from the at least one first pair of interconnected qubits. This means that the method according to the second aspect may deal with differently defined Hamiltonians, which increases its flexibility-in-use.

In one embodiment of the second aspect, the multi-qubit system is based on a set of Rydberg atoms. The set of Rydberg atoms is characterized by an atom spacing. In this embodiment, the resource Hamiltonian is defined based on the atom spacing. Thus, the method according to the second aspect may be used to perform the DAQC operation on the Rydberg atoms, thereby increasing its flexibility-in-use.

In another embodiment of the second aspect, the multi-qubit system is based on a set of nitrogen-vacancy (NV) centers. The set of NV centers is characterized by a NV center spacing. In this embodiment, the resource Hamiltonian is defined based on the NV center spacing. Thus, the method according to the second aspect may be used to perform the DAQC operation on the NV centers, thereby increasing its flexibility-in-use.

In one embodiment of the second aspect, the DAQC operation comprises a quantum Fourier transform or a generation of GHZ states. Given this, the method according to the second aspect may be applied to solve some of the most relevant tasks of the quantum computing, thereby increasing its flexibility-in-use.

In one embodiment of the second aspect, the first set of operating parameters comprises at least one first running time and at least one first coupling coefficient for the at least one analog block, while the second set of operating parameters comprises at least one second running time and at least one second coupling coefficient for the at least one analog block. By using these running times and coupling coefficients, one may tune the multi-qubit interaction strength during the DAQC operation in a simpler and more efficient manner.

In one embodiment of the second aspect, a number of the at least one first pair of interconnected qubits is equal to a number of the at least one second pair of interconnected qubits. In this case, the total qubit connectivity may be remained upon tuning the multi-qubit interaction strength during the DAQC operation. This may be useful in some DAQC-related applications.

In one embodiment of the second aspect, the conversion matrix is a binary matrix. The binary type of the conversion matrix is much easier to build and use when tuning the multi-qubit interaction strength during the DAQC operation.

In one embodiment of the second aspect, the second set of operating parameters is related with the first set of operating parameters via an inversion of the conversion matrix. This may allow one to tune the multi-qubit interaction strength during the DAQC operation in a much easier manner.

In one embodiment of the second aspect, the at least one first pair of interconnected qubits comprises non-overlapping pairs of interconnected qubits, and the at least one second pair of interconnected qubits comprises non-overlapping pairs of interconnected qubits. This means that the method according to the second aspect may be applied to the multi-qubit system with not all-to-all connectivity, i.e., when each pair of interconnected qubits comprises different qubits.

According to a third aspect, a computer program product is provided. The computer program product comprises a computer-readable storage medium that stores a computer code. Being executed by at least one CPU, the computer code causes the at least one CPU to perform the method according to the second aspect. By using such a computer program product, it is possible to simplify the implementation of the method according to the second aspect in any computing apparatus, like the apparatus according to the first aspect.

Other features and advantages of the invention will be apparent upon reading the following detailed description and reviewing the accompanying drawings.

### BRIEF DESCRIPTION OF THE DRAWINGS

The invention is explained below with reference to the accompanying drawings in which:

FIG. 1 shows a block diagram of an apparatus for performing a DAQC operation in a multi-qubit system in accordance with one exemplary embodiment of the invention;

FIG. 2 shows a flowchart of a method for performing a DAQC operation in a multi-qubit system in exemplary embodiment of the accordance with one exemplary invention;

FIG. 3 shows an exemplary 3×3 array of Rydberg atoms to be used for Greenberger-Horne-Zeilinger (GHZ) state generation;

FIG. 4 shows a quantum circuit that may be used to perform the GHZ state generation on 9 qubits placed in the array shown in FIG. 3 in accordance with the DQC paradigm;

FIG. 5 shows a quantum circuit that has the same function as the quantum circuit shown in FIG. 4 but uses other gates in accordance with the DAQC paradigm;

FIG. 6 shows a quantum circuit that may be used to perform a quantum Fourier transform on the 9 qubits placed in the array shown in FIG. 3 in accordance with the DOC paradigm; and

FIG. 7 shows a quantum circuit that is similar in function to a first CRk-gate of the quantum circuit shown in FIG. 6 in accordance with the DAQC paradigm.

### DETAILED DESCRIPTION

Various embodiments of the invention are further described in more detail with reference to the accompanying drawings. However, the invention may be embodied in many other forms and should not be construed as limited to any certain structure or function discussed in the following description. In contrast, these embodiments are provided to make the description of the invention detailed and complete.

According to the detailed description, it will be apparent to the ones skilled in the art that the scope of the invention encompasses any embodiment thereof, which is disclosed herein, irrespective of whether this embodiment is implemented independently or in concert with any other embodiment of the invention. For example, the apparatus and method disclosed herein may be implemented in practice by using any numbers of the embodiments provided herein. Furthermore, it should be understood that any embodiment of the invention may be implemented using one or more of the elements presented in the appended claims.

The word “exemplary” is used herein in the meaning of “used as an illustration”. Unless otherwise stated, any embodiment described herein as “exemplary” should not be construed as preferable or having an advantage over other embodiments.

Although the numerative terminology, such as “first”, “second”, etc., may be used herein to describe elements or features of the embodiments disclosed herein, the elements or features should not be limited this by numerative terminology. This numerative terminology is used herein only to distinguish one element or feature from another element or feature. For example, a first pair of interconnected qubits discussed below could be called a second pair of interconnected qubits, and vice versa, without departing from the teachings of the invention.

As used in the embodiments disclosed herein, a DAQC operation may refer to a computing operation based on the DAQC paradigm. In general, the DAQC paradigm is a combination of the DOC paradigm and the analog approach for the quantum computing (the so-called analog quantum simulation). Therefore, the DAQC paradigm involves using analog blocks together with digital blocks. The digital blocks may perform single-qubit unitary operations (e.g., qubit rotations), while the analog block may perform the time evolution of a known interaction Hamiltonian. Any combination of the digital and analog blocks constitutes a quantum circuit. The quantum circuit design depends on the DAQC operation to be performed. Non-restrictive examples of the DAQC operation may include a quantum Fourier transform or a generation of GHZ states, which are well-known in the art and the description thereof is therefore omitted herein.

The exemplary embodiments disclosed herein provide a technical solution that allows mitigating or even eliminating the drawbacks of the prior art which are mentioned in the description part “Background of invention”. In particular, the technical solution disclosed herein allows multi-qubit couplings in a multi-qubit system to be tuned during a DAQC operation. For this purpose, a conversion matrix is used, which allows one to go from a resource Hamiltonian of the multi-qubit system to a target Hamiltonian of suitable type. Since each of the resource and target Hamiltonians defines a different set of pairs of interconnected qubits in the multi-qubit system, it is possible, by using the conversion matrix, to effectively tune multi-qubit couplings during the DAQC operation and, as a consequence, properly tune operating parameters of analog blocks used in the DAQC operation (it should be also noted that the tunability of single-qubit rotations, i.e., digital blocks, is not a big problem in this technical field, for which reason it is not discussed herein). All of this may allow one to reduce computation errors during the DAQC operation, as well as to achieve higher fidelities as compared to the current quantum computer architectures.

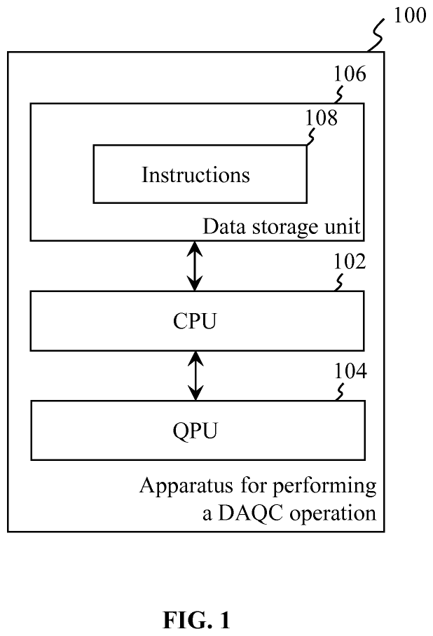

FIG. 1 shows a block diagram of an apparatus 100 for performing a DAQC operation in a multi-qubit system in accordance with one exemplary embodiment. The apparatus 100 is intended to be implemented as a quantum computing device, also referred to as a quantum computer. Therefore, non-restrictive implementation examples of the apparatus 100 may include superconducting quantum computers, trapped ion quantum computers, quantum computers based on spins in semiconductors, quantum computers based on cavity quantum electrodynamics, optical photon quantum computers, quantum computers based on defect centers in diamond, nitrogen-vacancy (NV) centers, ultracold atoms, Rydberg atoms, etc.

As shown in FIG. 1, the apparatus 100 comprises a central processing unit (CPU) 102, a quantum processing unit (QPU) 104, and a data storage unit 106. The QPU 104 is connected to the CPU 102. The data storage unit 106 is connected to the CPU 102 and stores processor-executable instructions 108. Being executed by the CPU 102, the processor-executable instructions 108 cause the CPU 102 to implement the aspects of the present invention, as will be described further in more detail. It should be noted that the number, arrangement, and interconnection of the constructive elements constituting the apparatus 100, which are shown in FIG. 1, are not intended to be any limitation of the present invention, but merely used to provide a general idea of how the constructive elements may be implemented within the apparatus 100. For example, each of the CPU 102 and the QPU 104 may be replaced with several corresponding processing units, as well as the data storage unit 106 may be replaced with several removable and/or fixed storage devices, depending on particular applications. Furthermore, the apparatus 100 may further comprise a transceiving unit (not shown) which, for example, may be configured to receive the processor-executable instructions 108 from a remote server and store them to the data storage unit 106 before the operation of the apparatus 100, as well as transmit the operation results of the apparatus 100 to the remote server.

The CPU 102 may be implemented as a general-purpose processor, single-purpose processor, microcontroller, microprocessor, application specific integrated circuit (ASIC), field programmable gate array (FPGA), digital signal processor (DSP), complex programmable logic device, etc. It should be also noted that the CPU 102 may be implemented as any combination of one or more of the aforesaid. As an example, the CPU 102 may be a combination of two or more microprocessors.

The QPU 104 may refer to a physical (fabricated) or simulated processor that contains a number of interconnected qubits. In this sense, the QPU 104 serves a quantum information storage device. The QPU 104 may include a single quantum processor, or two or more quantum processors. The QPU 104 may be based on a couple of Rydberg atoms held by optical tweezers in vacuum, or based on a 2D grid of transmon qubits on a chip. The QPU 104 may also take the form of superconducting quantum processor. The superconducting quantum processor may include multiple qubits and a plurality of superconducting coupling devices operable to selectively connect the qubits in pairs and couple the pairs therebetween. Examples of the superconducting coupling device may include radio frequency superconducting quantum interference devices (rf-SQUIDS) and direct current SQUIDs (dc-SQUIDs), which couple the qubits together by magnetic flux. Alternatively, charge-based coupling devices may be used in the QPU 104.

The data storage unit 106 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor-executable instructions 108 stored in the data storage unit 106 may be configured as a computer-executable code which causes the CPU 102 to implement the aspects of the present invention. The computer-executable code for carrying out operations or steps for the aspects of the present invention may be written in any combination of one or more programming languages, such as Java, C++, or the like. In some examples, the computer-executable code may be in the form of a high-level language or in a pre-compiled form and be generated by an interpreter (also pre-stored in the data storage unit 106) on the fly.

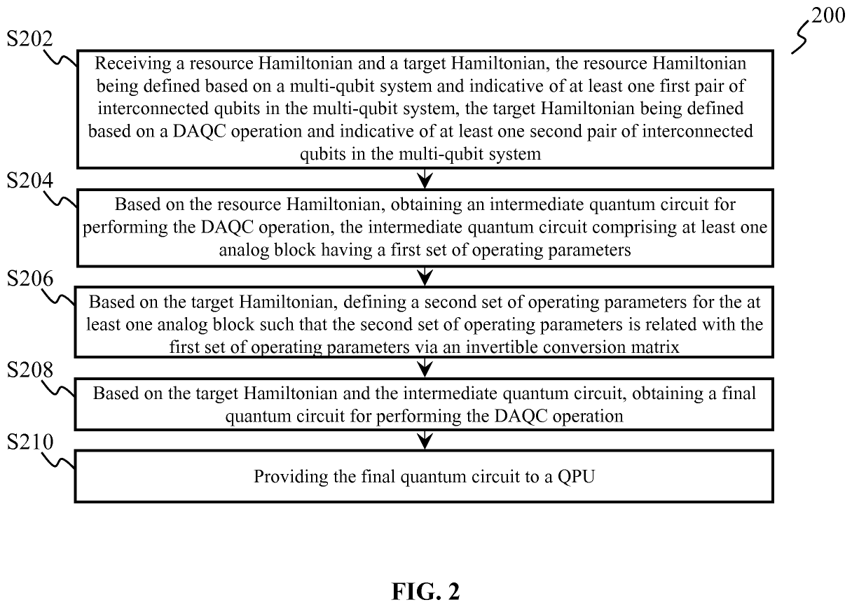

FIG. 2 shows a flowchart of a method 200 for performing a DAQC operation in a multi-qubit system in accordance with one exemplary embodiment. Each step of the method 200 is intended to be performed by the CPU 102 of the apparatus 100.

The method 200 starts with a step S202, in which the CPU 102 receives a resource Hamiltonian and a target Hamiltonian. The resource Hamiltonian is defined based on the multi-qubit system and indicative of one or more first pairs of interconnected qubits in the multi-qubit system. The target Hamiltonian is defined based on the DAQC operation and indicative of one or more second pairs of interconnected qubits in the multi-qubit system. The first pair(s) of interconnected qubits is (are) may be the same as or different from the second pair(s) of interconnected qubits, depending on particular applications. It should be also noted that the resource Hamiltonian and the target Hamiltonian may be provided to the CPU 102 from a remote server with which the apparatus 100 may be connected via the transceiving unit using any suitable type of wireless communications (e.g., mobile communications). Alternatively, the apparatus 100 may be additionally provided with a user-input device configured to receive the resource and target Hamiltonians from a user and provide them to the CPU 102 for further processing. Such a user-input device may provide a user interface (e.g., a graphical user interface). Some non-restrictive examples of the user-input device may include one or more microphones, an alphanumeric keypad, such as a keyboard, for inputting alphanumeric and other information, or a pointing device, such as a mouse, a trackball, stylus, or cursor direction keys. The user-input device may be also implemented as a touchscreen. As one other alternative, the data storage unit 106 may store a database of resource (default) Hamiltonians each corresponding to a particular type of multi-qubit systems, and the CPU 102 may, in the step S202 of the method 200, access the data storage unit 106 and select a required resource Hamiltonian for further processing; in this case, the target Hamiltonian may be provided to the CPU 102 either from the remote server or the user-input device.

Next, the method 200 proceeds to a step S204, in which the CPU 102 obtains, based on the resource Hamiltonian, an intermediate quantum circuit for performing the DAQC operation in the multi-qubit system. The intermediate quantum circuit comprises one or more analog blocks each having a first set of operating parameters. The intermediate quantum circuit may be considered as a roughly designed quantum circuit. After that, the method 200 goes on to a step S206, in which the CPU 102 defines, based on the target Hamiltonian, a second set of operating parameters for the analog block(s) such that the second set of operating parameters is related with the first set of operating parameters via an invertible conversion matrix. In other words, the second set of operating parameters is obtained by multiplying the first set of operating parameters by the conversion matrix. For example, the conversion matrix may be configured such that the second set of operating parameters are related with the first set of operating parameters via an inversion of the conversion matrix.

Further, the method 200 proceeds to a step S208, in which the CPU 102 uses the target Hamiltonian (or, in other words, the connectivity defined by the target Hamiltonian), as well as the intermediate quantum circuit, to obtain a final (finely designed) quantum circuit for performing the DAQC operation.

After that, the method 200 proceeds to a step S210, in which the CPU 102 provides the final quantum circuit to the QPU 104. By using the final quantum circuit, the QPU 104 may perform the DAQC operation.

In one embodiment, the multi-qubit system may be based on a set or array of Rydberg atoms (e.g., a 2D or 3D lattice of Rydberg atoms). It should be known to those skilled in the art that the array of Rydberg atoms is characterized by an atom spacing. In this case, the resource Hamiltonian may be defined based on the atom spacing. If required, an effective inter-atom interaction radius in the array of Rydberg atoms may be also considered when defining the resource Hamiltonian. In another embodiment, instead of Rydberg atoms, the multi-qubit system may be based on NV centers, whereupon the resource Hamiltonian may be defined based on an NV center spacing.

In some embodiments, the conversion matrix may be a binary matrix. The binary matrix may be constituted by any kind of binary elements, such, for example, as “1” and “−1”. The binary type of the conversion matrix is much easier to build and use when tuning the multi-qubit interaction strength during the DAQC operation.

In one embodiment, the first pair(s) of interconnected qubits may comprise non-overlapping pairs of interconnected qubits, and/or the second pair(s) of interconnected qubits may comprise non-overlapping pairs of interconnected qubits. In another embodiment, the first pair(s) of interconnected qubits and/or the second pair(s) of interconnected qubits may comprise overlapping pairs of interconnected qubits and even provide the so-called all-to-all connectivity. The latter means that each qubit of the multi-qubit system is connected to the rest of the qubits of the multi-qubit system. The decision on using the non-overlapping and/or overlapping pairs of interconnected qubits may depend on the multi-qubit system under consideration and the DAQC operation to be performed thereon. Furthermore, the number of the first pairs of interconnected qubits may be equal to the number of the second pairs of interconnected qubits, if required and depending on particular applications.

As for the first and second sets of operating parameters of the analog block(s), each of them may comprise one or more running times and one or more coupling coefficients for the analog block(s). In this case, the coupling coefficient(s) from the first set of operating parameters may correspond to the first pair(s) of interconnected qubits, while the coupling coefficient(s) of the second set of operating parameters may correspond to the second pair(s) of interconnected qubits. In other words, these coupling coefficients define qubit-qubit couplings in the multi-qubit system. By using these running times and coupling coefficients, one may tune the multi-qubit interaction strength during the DAQC operation in a simpler and more efficient manner. However, these types of the operating parameters should not be construed as any limitation of the present invention. In some other embodiments, any other parameters representative of the operation of the analog blocks may be used instead of the above-mentioned running times and coefficients. Moreover, the selection of the operating parameters may depend on a type of analog blocks used in the intermediate and final quantum circuits.

Let us now give one non-restrictive example of how to perform the steps of the method 200.

Assume that C=(j,k>j) is a qubit connectivity in a multi-qubit system of interest (e.g., an array of Rydberg atoms). In other words, C defines a collection of pairs of interconnected qubits in the multi-qubit system. In total, C has c elements (i.e., qubit-qubit connections). For example, the connectivity for an 1D array of qubits may be written as C_{1D}=(0,1), (1,2), (2,3), (3,4).

Additionally assume that the CPU 102 receives, in the step S202 of the method 200, the resource and target Hamiltonians each corresponding to the same connectivity C but different qubit-qubit connections (i.e., the first pair(s) of interconnected qubits is (are) different from the second pair(s) of interconnected qubits).

In the step S204 of the method 200, the CPU 102 uses the resource Hamiltonian to obtain an intermediate quantum circuit for performing a DAQC operation on the multi-qubit system. The intermediate quantum circuit is assumed to comprise one or more analog block(s) that implements the cross-Kerr-type (ZZ) interaction between the two qubits in each pair of interconnected qubits. The first set of operating parameters of the analog block(s) are again represented by running times and coupling coefficients. In this case, the resource Hamiltonian may be written as follows:

$${\overline{H}}_{ZZ} = {\sum }_{( j , k ) ∈ 𝒞} {\overline{g}}_{jk} {Z}^{j} {Z}^{k} ,$$

where Z^{j} and Z^{k} are the Z-Pauli operators acting on the qubits j and k, respectively; and g̅ⱼₖ is the coupling coefficient indicative of the connection between the qubits j and k in the resource Hamiltonian. The evolution under the resource Hamiltonian will give some running times for each analog block of the intermediate quantum circuit.

In the step S206 of the method 200, the CPU 102 uses the target Hamiltonian to define a second (different) set of operating parameters (i.e., different running times and coupling coefficients) of the analog block(s) such that the first and second set of operating parameters are interrelated via an invertible conversion matrix. The second set of operating parameters is more suitable for the DAQC operation of interest compared to the first set of operating parameters. In particular, the target Hamiltonian may be written as follows:

$${H}_{ZZ} = {\sum }_{( j , k ) ∈ 𝒞} {g}_{jk} {Z}^{j} {Z}^{k} ,$$

where gⱼₖ is the coupling coefficient indicative of the connection between the qubits j and k in the target Hamiltonian.

The interrelation between the first and second sets of operating parameters may be considered as the evolution under the target Hamiltonian by using the following unitary matrix:

$${U}_{ZZ} ( {t}_{F} ) = exp ( - i {\sum }_{( j , k ) ∈ 𝒞} {t}_{F} {g}_{jk} {Z}^{j} {Z}^{k} ) .$$

where t_{F} is some running time.

Next, the step S206 of the method 200 may be performed by the CPU 102 as follows. Let tₘₙ be the time that each analog block runs for. The intermediate quantum circuit is assumed to consist of c analog blocks each sandwiched by X-Pauli gates (which are one example of the digital blocks) on the corresponding pair of interconnected qubits. This can be written as follows:

$$\begin{matrix}{U}_{DAQC} = {\prod }_{( m , n ) ∈ 𝒞} {X}^{m} {X}^{n} exp ( - {it}_{mn} {\overline{H}}_{ZZ} ) {X}^{m} {X}^{n} \\ = {\prod }_{( m , n ) ∈ 𝒞} exp ( - {it}_{mn} {X}^{m} {X}^{n} {\overline{H}}_{ZZ} {X}^{m} {X}^{n} ) \\ = {\prod }_{( m , n ) ∈ 𝒞} exp ( - i {\sum }_{( j , k ) ∈ 𝒞} {t}_{mn} {\overline{g}}_{jk} {X}^{m} {X}^{n} {Z}^{j} {Z}^{k} {X}^{m} {X}^{n} ) ,\end{matrix}$$

where X^{m} is the X-Pauli operator acting on the qubit m; each tₘₙ is the time each analog block runs for; and Re^{A}R^{†}=E^{RAR}^{^{†}} is used (where R is the unitary matrix). By using the identity X^{m}Z^{j}X^{m}=(−1)^{δ}^{ₘⱼ}Z^{j} (where δₘⱼ is the Kronecker delta) in the above equation for U_{DAQC}, one can obtain the following:

$$\begin{matrix}{U}_{DAQC} = {\prod }_{( m , n ) ∈ 𝒞} exp ( - i {\sum }_{( j , k ) ∈ 𝒞} {t}_{mn} {\overline{g}}_{jk} ( - 1 \text{?} {Z}^{j} {Z}^{k} ) \\ {\prod }_{( m , n ) ∈ 𝒞} exp ( - i {\sum }_{( j , k ) ∈ 𝒞} {t}_{mn} {\overline{g}}_{jk} {M}_{mnjk} {Z}^{j} {Z}^{k} ) \\ exp ( - i {\sum }_{( m , n ) ∈ 𝒞} {\sum }_{( j , k ) ∈ ??} {t}_{mn} {\overline{g}}_{jk} {M}_{mnjk} {Z}^{j} {Z}^{k} ) .\end{matrix}$$

$$\text{?} \text{indicates text missing or illegible when filed}$$

U_{DAQC} can be now found because all the exponentials commute, so there is no Trotter error. By so doing, it is possible to obtain the set of elements Mₘₙⱼₖ=(−1)^{δ}^{ₙⱼ}^{+δ}^{ₘⱼ}^{+δ}^{ₙₖ}^{+δ}^{ₘₖ}. To obtain the conversion matrix of size c×c based on the elements Mₘₙⱼₖ, it is required to vectorize the pairs of interconnected qubits (m,n)→α and (j,k)→β.

As can be seen, the above equations for U_{DAQC} and U_{zz}(t_{F}) will be equal if the following condition is met:

t_{F}g_{β}=M_{αβ}t_{α}g̅_{β},

where the sum over repeated indices is implicit. In this condition, g_{β} are the c arbitrary coefficients which are to be obtained (i.e., those coupling coefficients which are related with the target Hamiltonian), M_{αβ} is the conversion matrix, and t_{α} are the running times of each analog block in the intermediate quantum circuit representing the DAQC operation, i.e., U_{DAQC}, in accordance with the target Hamiltonian. These running times may be adjusted to recover the arbitrary target coefficients g_{β}. This may be done by means of the inversion of the conversion matrix as follows:

$${t}_{α} = {( {M}^{- 1} )}_{α β} \begin{matrix}\underline{{g}_{β}} \\ \overline{{g}_{β}}\end{matrix} {t}_{F} .$$

The target Hamiltonian and the second set of operating parameters are then used to obtain a final quantum circuit in the step S208 of the method 200. That is, the target parameters t_{F} and g_{β} should be applied to the analogue blocks of the intermediate quantum circuit. The final quantum circuit should be subsequently provided to the QPU 104 in the step S210 of the method 200.

Let us now explain how the method 200 may be used to perform the GHZ state generation and the quantum Fourier transform on the multi-qubit system that is represented by an array of Rydberg atoms.

### GHZ State Generation

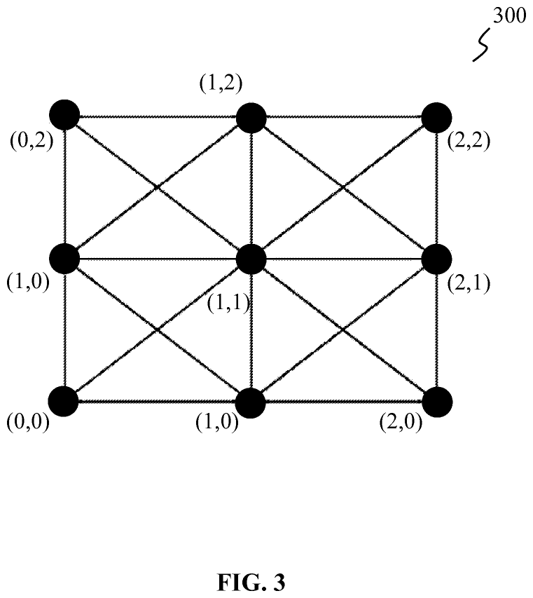

FIG. 3 shows an exemplary 3×3 array of Rydberg atoms 300 to be used for the GHZ state generation. Each Rydberg atom is schematically shown as a black solid circle. Further, 9 qubits are assumed to be placed in the array 300 with an effective interaction radius equal to 1.5 unit cell. This means that each qubit is connected to its nearest neighbors in four directions plus along diagonals. In other words, the central qubit of the array 300 is actually connected to all (i.e., 8) other qubits.

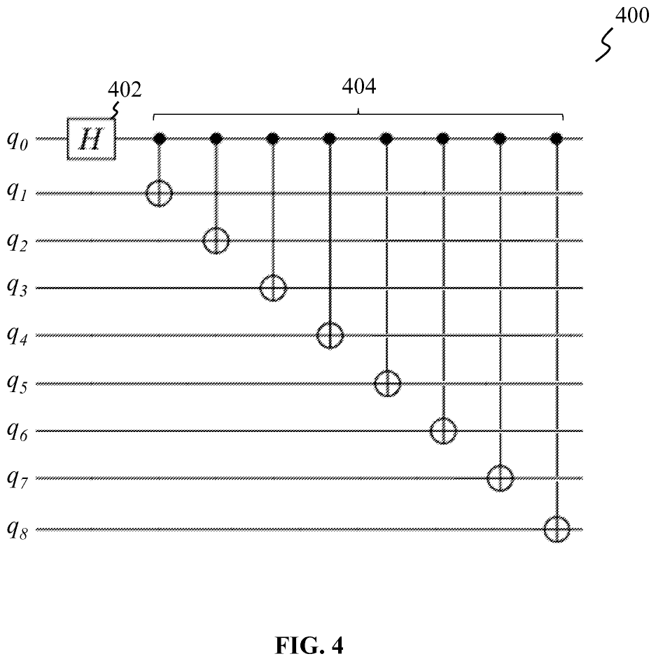

FIG. 4 shows a quantum circuit 400 that may be used to perform the GHZ state generation on the 9 qubits placed in the array 300 in accordance with the DQC paradigm. In particular, the GHZ state for the 9 qubits is given by

$$\vert GHZ 〉 = \frac{{{\vert 0 〉}^{⊗ M} + \vert 1 〉}^{⊗ M}}{\sqrt{2}} ,$$

where M=9 is the number of the qubits.

In the quantum circuit 400, it is assumed that the first qubit (i.e., q0) is connected to all other qubits. The quantum circuit 400 itself comprises an Hadamard gate (H-gate) 402 and a set 404 of CNOT-gates.

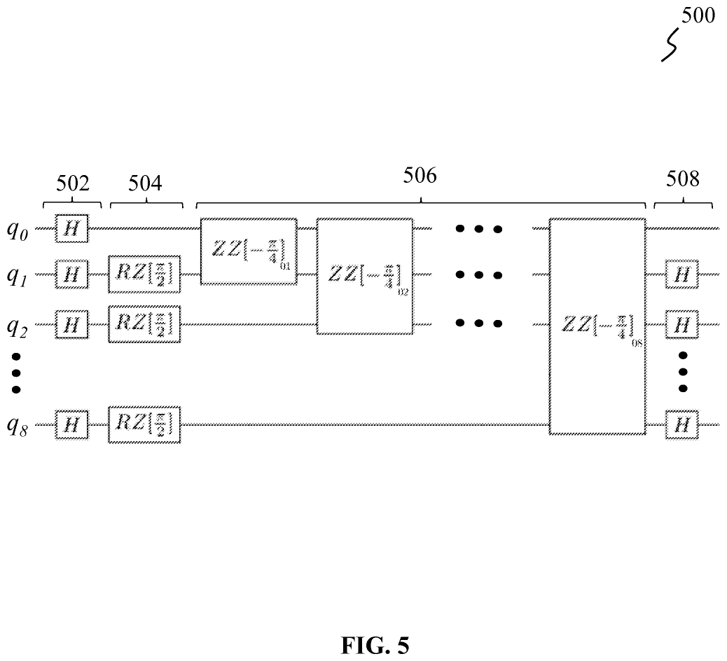

FIG. 5 shows a quantum circuit 500 that has the same function as the quantum circuit 400 but uses other gates in accordance with the DAQC paradigm. In particular, the quantum circuit 500 comprises an input set 502 of H-gates, a set 504 of RZ-gates, a set 506 of entangling ZZ-gates, and an output set 508 of H-gates. Each of these gates is well-known in the art, for which reason their description is omitted herein. It is just noted that each ZZ-gate has a form similar to the target Hamiltonian (this is the reason why the circuit 500 is used instead of the circuit 400). The quantum circuit 500 may be considered as the intermediate quantum circuit in terms of the method 200. Indeed, the parameters of the target Hamiltonian depend on the parameters of the ZZ-gates. The gates used in the quantum circuit 500 are defined as follows:

$$H = \frac{1}{\sqrt{2}} ( \begin{matrix}1 & 1 \\ 1 & - 1\end{matrix} ) ,$$

$$RZ [ θ ] = ( \begin{matrix}1 & 0 \\ 0 & {e}^{i θ / 2}\end{matrix} ) ,$$

$${ZZ}^{jk} [ ϕ ] = {e}^{i ϕ {Z}^{j} {Z}^{k}} = ( \begin{matrix}{e}^{i ϕ} & 0 & 0 & 0 \\ 0 & {e}^{- i ϕ} & 0 & 0 \\ 0 & 0 & {e}^{- i ϕ} & 0 \\ 0 & 0 & 0 & {e}^{i ϕ}\end{matrix} ) ,$$

wherein θ ϕ are the angles of qubit rotation.

It is further assumed that the set 506 of entangling ZZ-gates should be written as the evolution under the target Hamiltonian in the form:

$$H = {\sum }_{k = 1}^{8} \frac{- π}{4} {Z}^{0} {Z}^{k} .$$

In this case, the second set of operating parameters (i.e., the conversion matrix) and, consequently, may be obtained by using the method 200. Then, the quantum circuit 500 may be updated by using the second set of operating parameters to obtain the final quantum circuit for the GHZ state generation.

### Quantum Fourier Transform

Let us assume that the quantum Fourier transform is to be performed on the 9 qubits placed in the array 300 of Rydberg atoms.

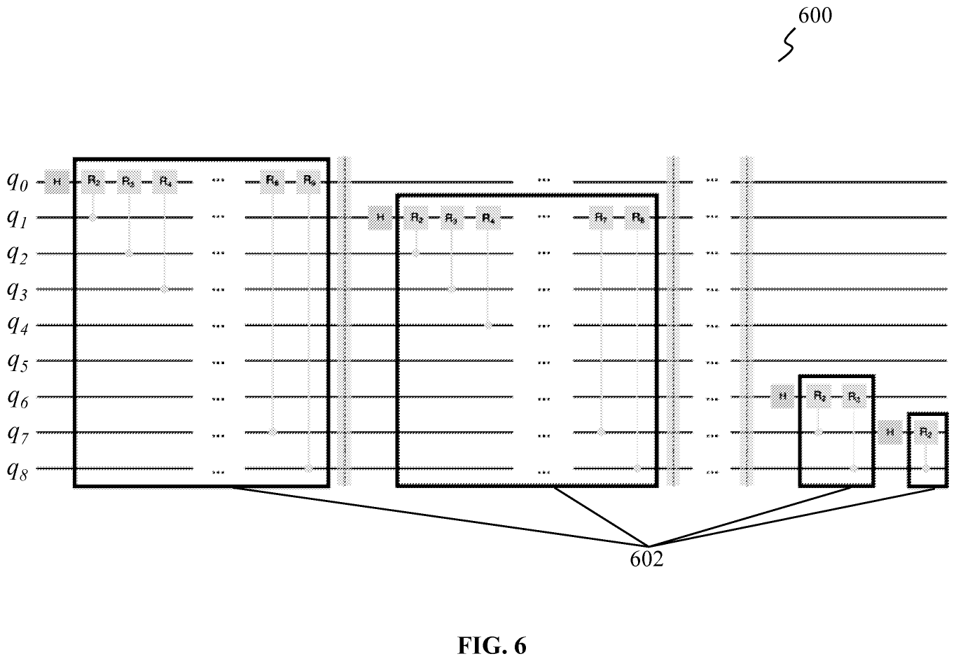

FIG. 6 shows a quantum circuit 600 that may be used to perform the quantum Fourier transform on the 9 qubits in accordance with the DOC paradigm. As shown in FIG. 6, the quantum circuit 600 comprises a set 602 of CRk-gates which are separated from each other by an H-gate. It is further assumed that the gates used in the quantum circuit 600 are defined as follows:

$$H = \frac{1}{\sqrt{2}} ( \begin{matrix}1 & 1 \\ 1 & - 1\end{matrix} ) ,$$

$$CRk = ( \begin{matrix}1 & 0 & 0 & 0 \\ 0 & 1 & 0 & 0 \\ 0 & 0 & 1 & 0 \\ 0 & 0 & 0 & {e}^{2 π i / {2}^{k}}\end{matrix} ) .$$

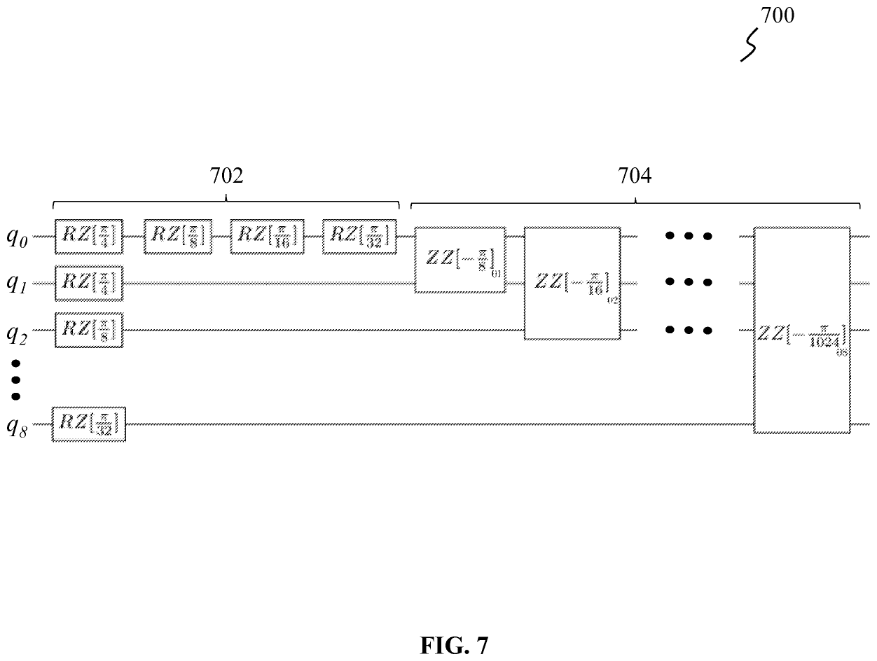

FIG. 7 shows a quantum circuit 700 that is similar in function to the first CRk-gate of the quantum circuit 600 in accordance with the DAQC paradigm. The first CRk-gate is arranged first on the left in FIG. 6. In particular, the quantum circuit 700 is obtained by transforming the first CRk-gate of the quantum circuit 600 into RZ rotations along with ZZ-gates. The quantum circuit 700 comprises a set 702 of RZ-gates and a set 704 of entangling ZZ-gates.

It is also assumed that the first (on the left in FIG. 7) ZZ-gate of the set 704 of entangling ZZ-gates is equivalent to the evolution under the target Hamiltonian of the form:

$$H = {\sum }_{k = 1}^{8} \frac{- π}{{2}^{k + 2}} {Z}^{0} {Z}^{k} ,$$

Again, the second set of operating parameters (i.e., the conversion matrix) and the final quantum circuit based thereon may be obtained by using the method 200.

The next action is to repeat the above process (i.e., build quantum circuits similar to the quantum circuit 700) for the rest CRk-gates of the set 602 of CRk-gates. For this purpose, one should bring all external qubits consecutively to the center by swapping them with the Swap gate:

$$Swap = ( \begin{matrix}1 & 0 & 0 & 0 \\ 0 & 0 & 1 & 0 \\ 0 & 1 & 0 & 0 \\ 0 & 0 & 0 & 1\end{matrix} )$$

Then, it is required to apply an Hadamard gate to the corresponding qubit and the method 200 again. As another example, the Hamiltonian for the second ZZ-gate of the set 704 of entangling ZZ-gates is as follows:

$$H = {\sum }_{k = 1}^{8} \frac{- π}{{2}^{k + 1}} {Z}^{0} {Z}^{k}$$

This process should be repeated until all the 9 qubits are exhausted.

It should be noted that each step or operation of the method 200, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the executable instructions which embody the steps or operations described above can be stored on a corresponding data carrier and executed by the CPU 102. This data carrier can be implemented as any computer-readable storage medium configured to be readable by the CPU 102 to execute the processor executable instructions. Such computer-readable storage media can include both volatile and nonvolatile media, removable and non-removable media. By way of example, and not limitation, the computer-readable media comprise media implemented in any method or technology suitable for r storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the exemplary embodiments of the invention are described herein, it should be noted that various changes and modifications could be made in the embodiments of the invention, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. An apparatus for performing a Digital-Analog Quantum Computation (DAQC) operation in a multi-qubit system, the apparatus comprising:
a data storage unit storing processor-executable instructions,
a central processing unit (CPU) connected to the data storage unit, and
a quantum processing unit (QPU) connected to the CPU,
wherein the CPU is configured, when executing the processor-executable instructions, to:
receive a resource Hamiltonian and a target Hamiltonian, the resource Hamiltonian being defined based on the multi-qubit system and indicative of at least one first pair of interconnected qubits in the multi-qubit system, the target Hamiltonian being defined based on the DAQC operation and indicative of at least one second pair of interconnected qubits in the multi-qubit system;
based on the resource Hamiltonian, obtain an intermediate quantum circuit for performing the DAQC operation, the intermediate quantum circuit comprising at least one analog block, the at least one analog block having a first set of operating parameters;
based on the target Hamiltonian, define a second set of operating parameters for the at least one analog block such that the second set of operating parameters is related with the first set of operating parameters via a conversion matrix, the conversion matrix being invertible;
based on the second set of operating parameters and the intermediate quantum circuit, obtain a final quantum circuit for performing the DAQC operation; and
provide the final quantum circuit to the QPU.

2. (canceled)

3. The apparatus of claim 1, wherein the multi-qubit system is based on a set of Rydberg atoms, the set of Rydberg atoms being characterized by an atom spacing, and wherein the resource Hamiltonian is defined based on the atom spacing.

4. The apparatus of claim 1, wherein the multi-qubit system is based on a set of nitrogen-vacancy (NV) centers, the set of NV centers being characterized by a NV center spacing, and wherein the resource Hamiltonian is defined based on the NV center spacing.

5. The apparatus of claim 1, wherein the DAQC operation comprises a quantum Fourier transform or a generation of Greenberger-Horne-Zeilinger (GHZ) states.

6. The apparatus of claim 1, wherein the first set of operating parameters comprises at least one first running time and at least one first coupling coefficient for the at least one analog block, and wherein the second set of operating parameters comprises at least one second running time and at least one second coupling coefficient for the at least one analog block.

7. (canceled)

8. (canceled)

9. The apparatus of claim 1, wherein the second set of operating parameters is related with the first set of operating parameters via an inversion of the conversion matrix.

10. The apparatus of claim 1, wherein the at least one first pair of interconnected qubits comprises non-overlapping pairs of interconnected qubits, and wherein the at least one second pair of interconnected qubits comprises non-overlapping pairs of interconnected qubits.

11. A method for performing a Digital-Analog Quantum Computation (DAQC) operation in a multi-qubit system, comprising:
by using a central processing unit (CPU):
receiving a resource Hamiltonian and a target Hamiltonian, the resource Hamiltonian being defined based on the multi-qubit system and indicative of at least one first pair of interconnected qubits in the multi-qubit system, the target Hamiltonian being defined based on the DAQC operation and indicative of at least one second pair of interconnected qubits in the multi-qubit system;
based on the resource Hamiltonian, obtaining an intermediate quantum circuit for performing the DAQC operation, the intermediate quantum circuit comprising at least one analog block, the at least one analog block having a first set of operating parameters;
based on the target Hamiltonian, defining a second set of operating parameters for the at least one analog block such that the second set of parameters is related with the first set of operating parameters via a conversion matrix, the conversion matrix being invertible;
based on the second set of operating parameters and the intermediate quantum circuit, obtaining a final quantum circuit for performing the DAQC operation; and
providing the final quantum circuit to a quantum processing unit (QPU).

12. (canceled)

13. The method of claim 11, wherein the multi-qubit system is based on a set of Rydberg atoms, the set of Rydberg atoms being characterized by an atom spacing, and wherein the resource Hamiltonian is defined based on the atom spacing.

14. The method of claim 11, wherein the multi-qubit system is based on a set of nitrogen-vacancy (NV) centers, the set of NV centers being characterized by a NV center spacing, and wherein the resource Hamiltonian is defined based on the NV center spacing.

15. The method of claim 11, wherein the DAQC operation comprises a quantum Fourier transform or a generation of Greenberger-Horne-Zeilinger (GHZ) states.

16. The method of claim 11, wherein the first set of operating parameters comprises at least one first running time and at least one first coupling coefficient for the at least one analog block, and wherein the second set of operating parameters comprises at least one second running time and at least one second coupling coefficient for the at least one analog block.

17. (canceled)

18. (canceled)

19. The method of claim 11, wherein the second set of operating parameters is related with the first set of operating parameters via an inversion of the conversion matrix.

20. The method of claim 11, wherein the at least one first pair of interconnected qubits comprises non-overlapping pairs of interconnected qubits, and wherein the at least one second pair of interconnected qubits comprises non-overlapping pairs of interconnected qubits.

21. (canceled)

22. The apparatus of claim 1, wherein the at least one second pair of interconnected qubits is different from the at least one first pair of interconnected qubits.

23. The apparatus of claim 1, wherein a number of the at least one first pair of interconnected qubits is equal to a number of the at least one second pair of interconnected qubits.

24. The apparatus of claim 1, wherein the conversion matrix is a binary matrix.

25. The method of claim 11, wherein the at least one second pair of interconnected qubits is different from the at least one first pair of interconnected qubits.

26. The method of claim 11, wherein a number of the at least one first pair of interconnected qubits is equal to a number of the at least one second pair of interconnected qubits.

27. A computer program product comprising a computer-readable storage medium, wherein the computer-readable storage medium stores a computer code which, when executed by at least one central-processing unit (CPU), causes the CPU to perform a Digital-Analog Quantum Computation (DAQC) operation in a multi-qubit system, comprising:
by using a central processing unit (CPU):
receiving a resource Hamiltonian and a target Hamiltonian, the resource Hamiltonian being defined based on the multi-qubit system and indicative of at least one first pair of interconnected qubits in the multi-qubit system, the target Hamiltonian being defined based on the DAQC operation and indicative of at least one second pair of interconnected qubits in the multi-qubit system;
based on the resource Hamiltonian, obtaining an intermediate quantum circuit for performing the DAQC operation, the intermediate quantum circuit comprising at least one analog block, the at least one analog block having a first set of operating parameters;
based on the target Hamiltonian, defining a second set of operating parameters for the at least one analog block such that the second set of parameters is related with the first set of operating parameters via a conversion matrix, the conversion matrix being invertible;
based on the second set of operating parameters and the intermediate quantum circuit, obtaining a final quantum circuit for performing the DAQC operation; and
providing the final quantum circuit to a quantum processing unit (QPU).
